(19) United States
(12) Patent Application Publication
(10) Pub. No.: US 2021/0300016 A1
(43) Pub. Date: Sep. 30, 2021

(54) PRINT SUBSTRATE ALIGNMENT

(71) Applicant: Hewlett-Packard Development Company, L.P., Spring, TX (US)

(72) Inventor: Jonathan Nir, Ness Ziona (IL)

(73) Assignee: Hewlett-Packard Development Company, L.P., Spring, TX (US)

(21) Appl. No.: 17/254,907

(22) PCT Filed: Dec. 7, 2018
(86) PCT No.: PCT/US2018/064384

§ 371 Date: Dec. 22, 2020

(51) Int. Cl. B41F 21/14; B41F 21/04

(52) U.S. Cl. CPC B41F 21/14; B41F 21/04

(57) ABSTRACT

Lateral adjustment apparatus comprises a gripper to grip a print substrate, the gripper being mounted on a rotor rotatable about a lateral axis, and a lateral adjustment motor to drive movement of the gripper laterally along the rotor to adjust a lateral position of the print substrate. The lateral adjustment motor is mounted on the rotor.

### BACKGROUND

Printing devices may be used to print representations, such as text or images, onto print substrates. Printing devices may include feed apparatus and print apparatus. The feed apparatus may be to adjust a position of an input print substrate to try to ensure that representations printed by the print apparatus appear in the intended locations on the print substrate. The feed apparatus may adjust the positioning of the input print substrate to compensate for either or both of a lateral offset and a rotational offset (otherwise referred to as “skew”) of the print substrate position relative to the print apparatus.

### FIGURES

Various examples will be described below with reference to the following figures, wherein:

FIG. 1 is schematic illustration of example lateral adjustment apparatus for adjusting the lateral position of a print substrate in a printing device;

FIG. 2 is a schematic illustration of an example printing device including lateral adjustment apparatus;

FIG. 3 is a schematic illustration of an example printing device including feed apparatus, lateral adjustment apparatus and print apparatus;

FIG. 4 is a schematic illustration of example lateral adjustment apparatus having received a print substrate, prior to lateral adjustment;

FIG. 5 is a schematic illustration of the example lateral adjustment apparatus of FIG. 4 following adjustment of the lateral position of the print substrate;

FIG. 6 is a schematic illustration of example lateral adjustment apparatus for adjusting the lateral position of a print substrate in a printing device;

FIG. 7 is a schematic illustration of example lateral adjustment apparatus for adjusting the lateral position of a print substrate in a printing device;

FIG. 8 is a schematic cross-section through the example lateral adjustment apparatus of FIG. 7;

FIG. 9 is a schematic illustration of an example printing device including feed apparatus, lateral adjustment apparatus, print apparatus, a camera and a controller; and

FIG. 10 provides a series of example schematic diagrams illustrating a method of transferring and adjusting the location of a print substrate in a printing device, such as the printing device shown in FIG. 9.

### DESCRIPTION

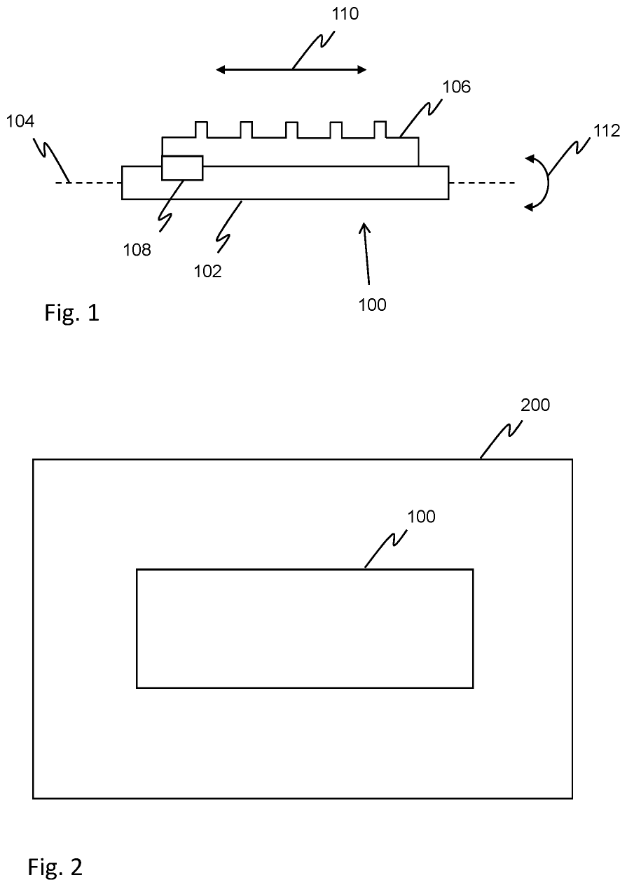

FIG. 1 is a schematic illustration of an example lateral adjustment apparatus 100. The lateral adjustment apparatus 100 comprises a rotor 102 which extends along a lateral axis 104, about which the rotor is rotatable. The lateral adjustment apparatus 100 further comprises a gripper 106 to grip a print substrate. The gripper 106 is mounted on the rotor 102. The lateral adjustment apparatus 100 also comprises a lateral adjustment motor 108 to drive movement of the gripper 106 laterally along the rotor 102 (e.g. along a direction, indicated by arrows 110, substantially parallel to the lateral axis 104) to adjust a lateral position of a print substrate gripped by the gripper 106. The lateral adjustment motor 108 is mounted on the rotor 102. Accordingly, the gripper 106 and the lateral adjustment motor 108 may be rotatable about the lateral axis 104 together with the rotor 102 in the direction indicated by arrows 112. As shown in FIG. 1, the lateral adjustment motor 108 may be located within a lateral extent of the gripper 106.

A lateral adjustment apparatus 100 of the type shown in FIG. 1 is suitable for use in a printing device 200, as illustrated schematically in FIG. 2. The lateral adjustment apparatus 100 may be used to adjust the lateral position of a print substrate within the printing device 200. The structure of the lateral adjustment apparatus 100 is particularly compact, which may enable integration of the lateral adjustment apparatus into a range of different types and sizes of printing device. In particular, the lateral adjustment apparatus 100 may be suitable for use in a digital printing device. The structure is also mechanically simple, which may enable a simple and cost-effective manufacturing process. Because the lateral adjustment motor 108 of the lateral adjustment apparatus 100 is mounted on the rotor 102, the lateral adjustment motor 108 may be located within the same region of a housing (not shown) as the gripper 106, and therefore may be separated from regions of the printing device detrimental to the functioning of a motor (for example, due to the presence of printing chemicals or due to high temperatures). It has also been found that, by mounting the lateral adjustment motor on the same rotor as the gripper, it is possible to achieve larger lateral displacements of the gripper along the rotor, more accurately, particularly in comparison to lateral adjustment mechanisms involving a lateral adjustment motor separate from the rotor.

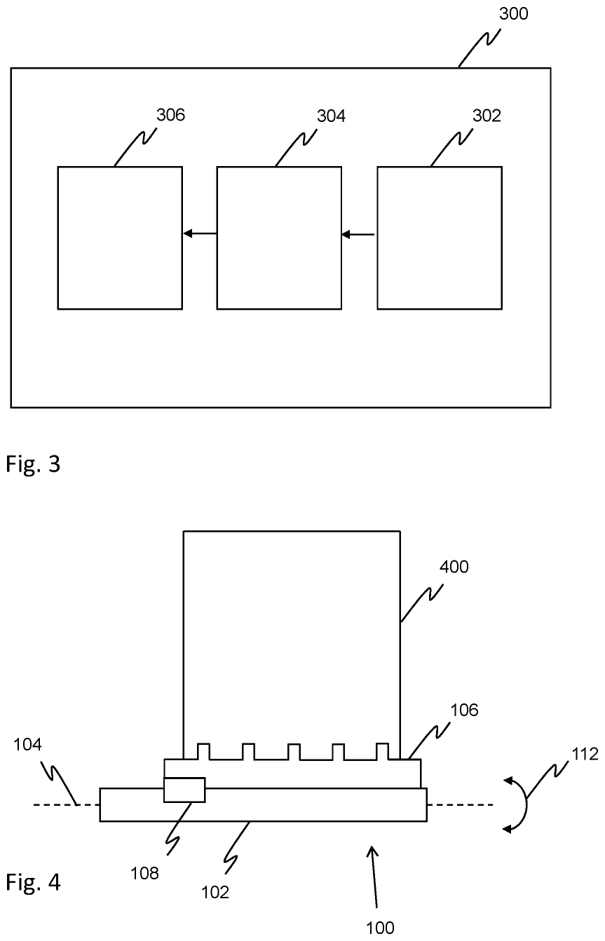

For example, FIG. 3 shows a printing device 300 which includes feed apparatus 302, lateral adjustment apparatus 304 and print apparatus 306. In the example shown in FIG. 3, the lateral adjustment apparatus 304 is located between the feed apparatus 302 and the print apparatus 306. In some examples, the lateral adjustment apparatus 304 may form part of the feed apparatus 302. The feed apparatus 302 feeds a print substrate, for example from a feeder pile (not shown), to the lateral adjustment apparatus 304. The lateral position of the print substrate, relative to the print apparatus, is adjusted by the lateral adjustment apparatus 304 before or during feeding of the print substrate to the print apparatus 306. The print apparatus 306 prints representations, such as images or text, onto the print substrate. For example, the print apparatus may include an impression cylinder for printing representations onto the print substrate. By adjusting the lateral position of the print substrate before or during feeding of the print substrate to the print apparatus 304, the print apparatus 304 prints representations onto the print substrate in a predetermined lateral location on the print substrate. The feed apparatus 302 may also adjust the angular orientation of incoming print substrate relative to the print apparatus 306 to correct for print substrate skew. For example, the feed apparatus 302 may comprise skew correction apparatus to rotate the print substrate to correct print substrate skew.

FIGS. 4 and 5 illustrate schematically a method by which lateral adjustment apparatus 100 may adjust the lateral position of a print substrate. In FIG. 4, the lateral adjustment apparatus 100 has received an incoming print substrate 400. The gripper 106 of the lateral adjustment apparatus 100 grips the print substrate 400. The lateral adjustment motor 108 then actuates lateral movement of the gripper 106 along the rotor 102. Since the gripper 106 grips the print substrate 400, the print substrate is moved laterally along the rotor 102 with the gripper 106, as illustrated in FIG. 5.

The rotor 102 may rotate about the lateral axis 104 as the lateral adjustment motor 108 moves the gripper 106 laterally along the rotor 102. The gripper 106, the lateral adjustment motor 108 and the print substrate 400 may rotate about the lateral axis 104 together with the rotor 102. Simultaneous rotation of the rotor 102 and lateral movement of the gripper 106 may enable lateral adjustment of the position of the print substrate 400 during feeding of the print substrate 400 to a print apparatus. In other examples, the rotor 102 may remain static as the lateral adjustment motor 108 moves the gripper 106 and the print substrate 400 laterally along the rotor 102. The rotor 102 may then rotate about the lateral axis 104, the gripper 106, the lateral adjustment motor 108 and print substrate 400 rotating about the lateral axis 104 together with the rotor 102. Sequential lateral movement of the gripper 106 and rotation of the rotor 102 may enable lateral adjustment of the position of the print substrate 400 prior to feeding of the print substrate 400 to a print apparatus.

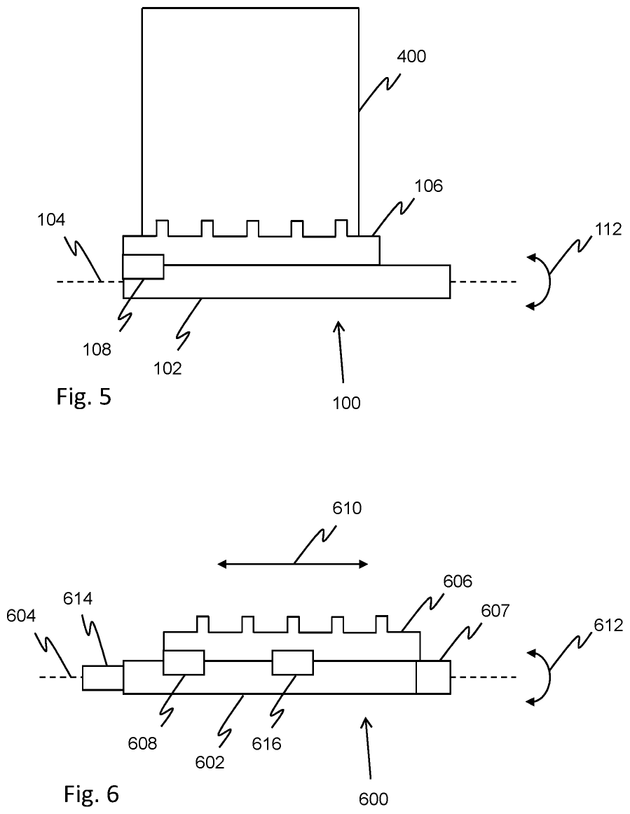

FIG. 6 is a schematic illustration of an example lateral adjustment apparatus 600. The lateral adjustment apparatus 600 comprises a rotor 602 which extends along a lateral axis 604, about which the rotor 602 is rotatable. The lateral adjustment apparatus 600 further comprises a gripper 606 to grip a print substrate. The gripper 606 is mounted on the rotor 602. The lateral adjustment apparatus 600 also comprises: a lateral adjustment motor 608 to drive movement of the gripper 606 laterally along the rotor 602 (e.g. along a direction, indicated by arrows 610, substantially parallel to the lateral axis 604) to adjust a lateral position of a print substrate gripped by the gripper 606; a rotor motor 614 to drive rotation of the rotor about the lateral axis 604; a gripper motor 616 to drive actuation of the gripper 606; and a slip ring 607. Actuation of the gripper 606 may comprise gripping or releasing a print substrate, for example by opening or closing gripper jaws around the print substrate.

The lateral adjustment motor 608 and the gripper motor 616 are mounted on the rotor 602. Accordingly, the gripper 606, the lateral adjustment motor 608 and the gripper motor 616 may be rotatable about the lateral axis 604 together with the rotor 602 in the direction indicated by arrows 612. The rotor motor 614 is operatively connected to the rotor 602 to drive rotation of the rotor 602 about the lateral axis 604. The rotor motor 614 is not mounted on the rotor 602; instead the rotor motor 614 is mounted externally to the rotor 602, for example on a wall, such as an exterior wall, of a housing (not shown). Accordingly, the rotor motor 614 may not rotate together with the rotor 602.

The lateral adjustment motor 608 and the gripper motor 616 are electrically connected, for example by way of electrically conducting brush contacts, to the slip ring 607. The slip ring 607 is itself connected to a power supply (not shown). The slip ring 607 is fixedly mounted at an end of the rotor 602, laterally displaced from the lateral adjustment motor 608 and the gripper motor 616, and remains static as the rotor 602 rotates about its axis. Accordingly, the slip ring 607 allows the lateral adjustment motor 608 and the gripper motor 616 to maintain electrical connection to the power supply as the rotor 602 rotates.

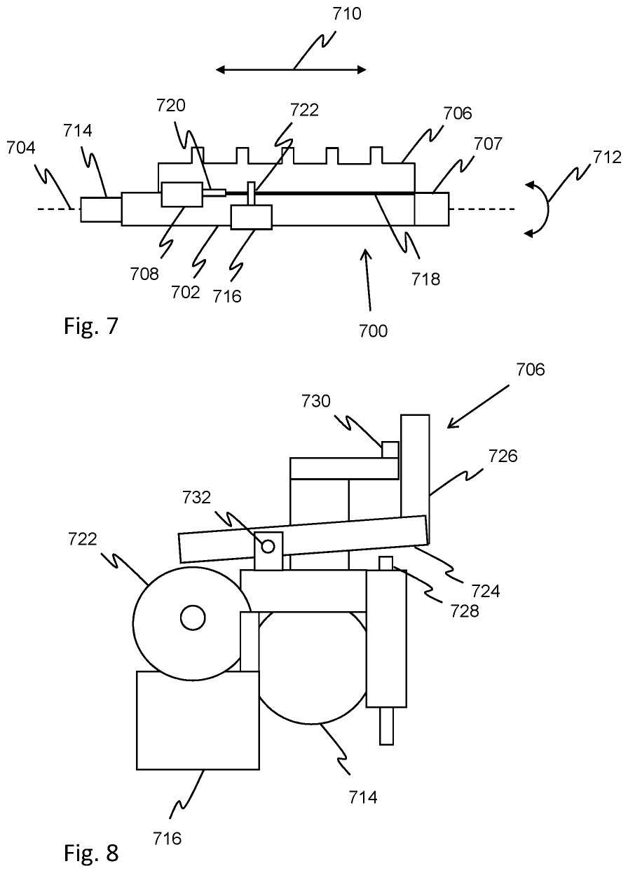

FIG. 7 is a schematic illustration of an example lateral adjustment apparatus 700. The lateral adjustment apparatus 700 comprises a rotor 702 which extends along a lateral axis 704, about which the rotor 702 is rotatable. The lateral adjustment apparatus 700 further comprises a gripper 706 to grip a print substrate. The gripper 706 is mounted on the rotor 702. The lateral adjustment apparatus 700 also comprises: a lateral adjustment motor 708 to drive movement of the gripper 706 laterally along the rotor 702 (e.g. along a direction, indicated by arrows 710, substantially parallel to the lateral axis 704) to adjust a lateral position of a print substrate gripped by the gripper 706; a rotor motor 714 to drive rotation of the rotor about the lateral axis 704; a gripper motor 716 to drive actuation of the gripper 706; and a slip ring 707. Actuation of the gripper 706 may comprise gripping or releasing a print substrate, for example by opening or closing gripper jaws around the print substrate.

The lateral adjustment motor 708 and the gripper motor 716 are mounted on the rotor 702. Accordingly, the gripper 706, the lateral adjustment motor 708 and the gripper motor 716 may be rotatable about the lateral axis 704 together with the rotor 702 in the direction indicated by arrows 712. The rotor motor 714 is operatively connected to the rotor 702 to drive rotation of the rotor 702 about the lateral axis 704. The rotor motor 714 is not mounted on the rotor 702; instead the rotor motor 714 is mounted externally to the rotor 702, for example on a wall, such as an exterior wall, a housing (not shown).

The gripper 706 is mounted on the rotor 702 by way of a rail 718 which extends along and is fixedly attached to the rotor 702. The gripper 706 is movably mounted on the rail 718 such that the gripper 706 is slidable along at least a portion of the length of the rail 718. The lateral adjustment motor 708 is operatively coupled to the gripper 706 by a linear actuator 720 such as a ball screw. The lateral adjustment motor 708 drives movement of the gripper 706 along the rail 718 by actuating the linear actuator 720. Use of a linear actuator such as a ball screw may enable lateral movement of the gripper along the rotor to be controlled accurately, without requiring complex control systems.

The lateral adjustment motor 708 and the gripper motor 716 are electrically connected, for example by way of electrically conducting brush contacts, to the slip ring 707. The slip ring 707 is itself connected to a power supply (not shown). The slip ring 707 is fixedly mounted at an end of the rotor 702, laterally displaced from the lateral adjustment motor 708 and the gripper motor 716, and remains static as the rotor 702 rotates about its axis. Accordingly, the slip ring 707 allows the lateral adjustment motor 708 and the gripper motor 716 to maintain electrical connection to the power supply as the rotor 702 rotates.

The gripper motor 716 mechanism is illustrated in more detail in FIG. 8. The gripper motor 716 is a cam motor which includes a cam 722 to drive movement of a lever 724 coupled to a gripper arm 726. The mechanism also includes a spring 728, which biases the gripper arm 726 towards a closed position against a gripper anvil 730. Actuation of the gripper 706 involves rotation of the cam 722 to move the gripper arm 726 away from the anvil 730, against the spring 278, by pivoting the lever 724 about pivot point 732. The gripper arm 726 and the gripper anvil 730 together function as gripper jaws for gripping a print substrate.

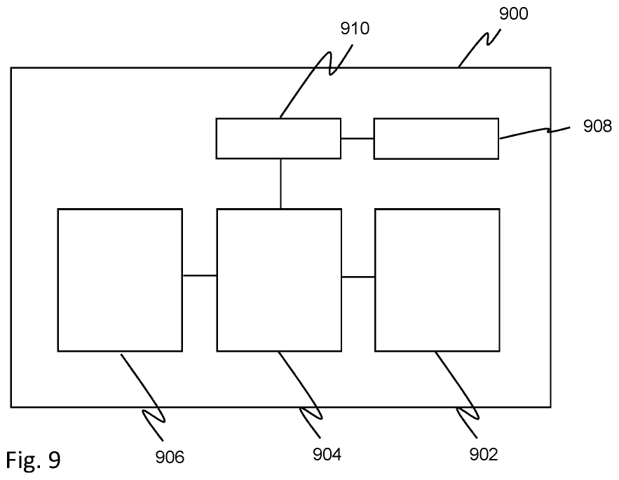

FIG. 9 illustrates schematically an example printing device 900 which includes feed apparatus 902, lateral adjustment apparatus 904 (of the types shown in, for example, FIG. 1, 6 or 7), print apparatus 906, a camera 908 and a controller 910. In the example shown in FIG. 9, the lateral adjustment apparatus 904 is located between the feed apparatus 902 and the print apparatus 906. In some examples, the lateral adjustment apparatus 904 may form part of the feed apparatus 902.

The feed apparatus 902 feeds print substrate, for example from a feeder pile (not shown), to the lateral adjustment apparatus 904. The camera 908 captures an image of at least a portion of the print substrate. The controller 910 determines a location of the print substrate from the image to determine a distance of the print substrate from a predetermined location. The lateral position of the print substrate, relative to the print apparatus, is adjusted by the lateral adjustment apparatus 904 before or during feeding of the print substrate to the print apparatus 906. In particular, the controller 910 controls the lateral adjustment apparatus 904 to adjust the lateral position of the print substrate based on the determined distance of the print substrate from the predetermined location. The print apparatus 906 prints representations, such as images or text, onto the print substrate. For example, the print apparatus may include an impression cylinder to print representations onto the print substrate. By adjusting the lateral position of the print substrate before or during feeding of the print substrate to the print apparatus 904, the print apparatus 904 prints representations onto the print substrate in the correct lateral location. The feed apparatus 902 may also adjust the angular orientation of incoming print substrate relative to the print apparatus 906 to correct for print substrate skew.

The camera 908 may be a digital camera to capture two-dimensional (2D) images as digital files to be stored. The images captured by the camera may be black and white images or colour images. The controller 910 may analyse the images captured by the camera 908 to find the location of the print substrate.

The controller 910 may include data processing apparatus comprising, or in communication with, a memory storing computer executable instructions and/or data for determining the location of the print substrate from images captured by the camera 908. The controller 910 may be directly or indirectly connected to the camera 908. The controller 910 may communicate with the camera 908. The camera 908 may send a digital file of a captured image to the control 910. The controller 910 may analyse the captured image (e.g. the digital file of the captured image) to locate the print substrate.

The controller 910 may determine a location of a portion of a side edge of the print substrate from the image to determine a distance of the print substrate from a predetermined location. In some examples, the controller 910 may determine a location of a corner of the print substrate from the image to determine a distance of the print substrate from a predetermined location.

The controller 910 may determine the time at which the camera 908 captures the image. The controller 910 may control the camera 908 to capture an image at a specific predetermined time or it may repeatedly capture images, for example at a predetermined time interval. The controller 910 may control the time interval. The controller 910 may determine the time at which the camera 908 captures the image based on sensor information from a sensor connected to the controller 910. The sensor may detect a print substrate and inform the controller 910 such that the controller 910 can then control the camera 908 to capture an image of the print substrate. In some examples, the camera 908 may be a video camera to sense the presence of a print substrate and capture an image when a print substrate is present. The controller 910 may also control the positioning of the camera 908, for example, the tilt, height or location of the camera 908 relative to the print substrate.

The controller 910 may be directly or indirectly connected to the lateral adjustment apparatus 904. The controller 910 may communicate with the lateral adjustment apparatus 904. The controller 910 may send instructions to the lateral adjustment apparatus 904 based on the information derived from the image. For example, the controller 910 may send instructions to various components of the lateral adjustment apparatus 904 to allow the various components of the lateral adjustment apparatus 904 to adjust the lateral position of the print substrate, relative to the direction of transport of the substrate, based on the determined location and the distance to the predetermined location. For example, the controller 910 may operate a lateral adjustment motor, a gripper motor and/or a rotor motor of the lateral adjustment apparatus 904 to cause the lateral adjustment apparatus 904 to adjust the lateral position of the print substrate, relative to the direction of transport of the substrate, based on the determined location and the distance to the predetermined location.

The location of the print substrate, for example the location of a portion of a side edge of the print substrate and/or the location of a corner of the print substrate, may be determined using any suitable image processing methods in the field, including any suitable edge detection and/or corner detection methods. For example, the controller 910 may determine the location of a portion of a side edge or a corner of the print substrate by comparing the colour, brightness or contrast of two or more pixels located in different regions of the captured image of the print substrate. For example, the controller 910 may detect a portion of a side edge or a corner by detecting contrasts in colours or greyscale between different regions of the captured image of the print substrate. The controller 910 may also take into account gradients in contrast in colour or greyscale across a plurality of pixels in the captured image.

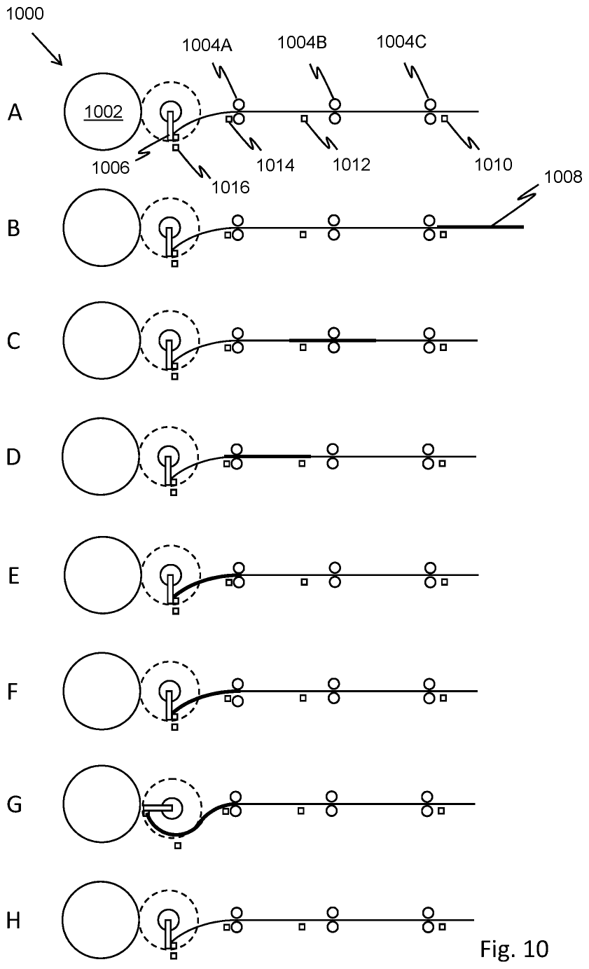

FIGS. 10A to 10H provide a series of example schematic diagrams illustrating a method in which feed apparatus and lateral adjustment apparatus transfer a print substrate to print apparatus while adjusting the lateral position of the print substrate. The schematic diagrams of FIG. 10A to 10H show a side view of an apparatus 1000 for adjusting the position of the print substrate according to an example. FIG. 10A illustrates the apparatus without a print substrate. The apparatus 1000 comprises a print impression cylinder 1002, nip rollers 1004A, 1004B and 1004C, and gripper 1006 located on an arm. The gripper 1006 may be located both above and below the print substrate such that when the gripper is closed the print substrate is held by the gripper. The apparatus 1000 also includes sensors 1010, 1012 and 1014 to detect the print substrate and determining print substrate skew and a camera 1016 to capture an image of the print substrate. The gripper 1006 and nip rollers 1004A may form part of the lateral adjustment apparatus. Nip rollers 1004B and 1004C may form part of the feed apparatus. The impression cylinder may form part of the print apparatus.

With respect to FIG. 10, firstly, a print substrate 1008 is detected. As shown in FIG. 10B, sensor 1010 detects the print substrate 1008. The nip rollers 1004A, 1004B and 1004C are activated to drive movement of the print substrate 1008 towards the cylinder 1002. As the print substrate moves forward, as shown in FIG. 100, sensor 1012 measures the skew of the print substrate. When sensor 1014 detects the print substrate, the printing device begins a sequence to adjust the orientation of the print substrate 1008 to correct for skew based on the measurements taken previously by sensor 1012. The adjustment to correct skew may be a rotation of the print substrate 1008. For example, nip rollers 1004A and/or 1004B may rotate to transport the print substrate 1008 forward and, for skew correction, the front edge may be driven into a barrier for frontal alignment. In more detail, when a portion of the leading edge of the print substrate 1008 is incident on the barrier, some nip rollers may continue to move while others are held still to rotate the substrate to drive more of the leading edge against the barrier. The barrier (not shown in FIGS. 10A to 10H) may be formed by the gripper 1006.

After skew has been corrected, the printing device performs lateral adjustment of the print substrate. As shown in FIG. 10D, the gripper 1006 closes around the print substrate 1008 such that it grips the print substrate. The print substrate is also gripped by the nip rollers 1004A closest to the grippers. While the print substrate is held still, the camera 1016 captures an image of at least a portion of the print substrate 1008, as shown in FIG. 10E. The nip rollers 1004A gripping the substrate are then disengaged to release the print substrate to allow the print substrate to move, as shown in FIG. 10F. Once the nip rollers 1004A are disengaged, a lateral adjustment motor drives lateral movement of the gripper 1006 to adjust the lateral position of the substrate based on the captured image.

The aligned print substrate 1008 is then fed, as shown in FIG. 10G, onto the impression cylinder 1002. This may be achieved by a rotor gripper driving rotation of the gripper 1006 together with the print substrate 1008 to provide the print substrate 1008 to the impression cylinder 1002. The gripper may then be rotated back to its starting configuration, as shown in FIG. 10H, where the system is reset, ready to receive another print substrate.

Apparatus 1000 of FIGS. 10A to 10H is an example apparatus and some elements within the apparatus may be removed or replaced with other elements and the order that the elements appear may change. For example, the apparatus 1000 may include any components described with respect to the preceding Figures, including a rotor, a gripper, a lateral adjustment motor, a gripper motor, a rotor motor, a slip ring, a rail, a linear actuator and/or a housing. The sensor used to measure the print substrate skew may be the same or a different sensor to that used to detect the presence of the print substrate. Moreover, either sensor may be placed on or next to the nip rollers. A single pair or a plurality of pairs of nip rollers may grip the print substrate and then disengage to release the print substrate and the number of nip rollers used to grip the print substrate may be dependent on the distance between the nip rollers and on the size and shape of the substrate. In an example, instead of being fed onto the impression cylinder, the aligned print substrate can be fed into different types of print apparatus.

It will be understood that various modifications and improvements can be made without departing from the concepts described herein. Except where mutually exclusive, any of the features may be employed separately or in combination with any other features and the disclosure extends to and includes all combinations and sub-combinations of one or more features described herein.

1. Lateral adjustment apparatus comprising:
a gripper to grip a print substrate, the gripper being mounted on a rotor rotatable about a lateral axis; and
a lateral adjustment motor to drive movement of the gripper laterally along the rotor to adjust a lateral position of the print substrate;
wherein the lateral adjustment motor is mounted on the rotor.

2. Lateral adjustment apparatus according to claim 1, wherein the lateral adjustment motor is electrically connected to a power supply by way of a slip ring.

3. Lateral adjustment apparatus according to claim 1, wherein the lateral adjustment motor is within a lateral extent of the gripper.

4. Lateral adjustment apparatus according to claim 1, wherein the lateral adjustment motor is located in the same region of a housing as the gripper.

5. Lateral adjustment apparatus according to claim 1, wherein the lateral adjustment motor is mounted on the rotor so as to rotate together with the rotor.

6. Lateral adjustment apparatus according to claim 1, wherein the gripper is mounted on the rotor by way of being movably mounted on a rail and the lateral adjustment motor is to drive movement of the gripper laterally along the rail.

7. Lateral adjustment apparatus according to claim 1, wherein the lateral adjustment motor is operatively coupled to the gripper by way of a ball screw.

8. Lateral adjustment apparatus according to claim 1 further comprising a rotor motor to drive rotation of the rotor and/or a gripper motor to drive actuation of the gripper, the gripper motor being mounted on the rotor.

9. A printing device comprising lateral adjustment apparatus, the lateral adjustment apparatus comprising:
a gripper to grip a print substrate, the gripper being mounted on a rotor rotatable about a lateral axis; and
a lateral adjustment motor to drive movement of the gripper laterally along the rotor to adjust a lateral position of the print substrate;
wherein the lateral adjustment motor is mounted on the rotor.

10. A printing device according to claim 9 further comprising:
a camera to capture an image of at least a portion of the print substrate; and
a controller to determine a location of the substrate from the image to determine a distance of the print substrate from a predetermined location.

11. A printing device according to claim 10, wherein the controller is to control the lateral adjustment apparatus to adjust the lateral position of the print substrate based on the determined distance of the print substrate from the predetermined location.

12. A printing device according to claim 10, wherein the controller is to determine a location of a portion of a side edge of the print substrate or a location of a corner of the print substrate from the captured image and to control the lateral adjustment apparatus to adjust the lateral position of the print substrate such that the portion of the side edge of the print substrate or the corner of the print substrate is relocated to a predetermined location.

13. A printing device according to claim 9 further comprising feed apparatus and print apparatus, the lateral adjustment apparatus being located between the feed apparatus and the print apparatus.

14. The printing device according to claim 13, wherein the feed apparatus comprises skew correction apparatus to rotate the print substrate to correct skew.

15. Lateral adjustment apparatus comprising:
a rotor rotatable about a lateral axis;
a gripper to grip a print substrate, the gripper being movably mounted on the rotor by way of a laterally extending rail;
a lateral adjustment motor, mounted on the rotor, to drive lateral movement of the gripper along the rail; and
a rotor motor to drive rotation of the rotor about the lateral axis.
